(19) United States
(12) Patent Application Publication
(10) Pub. No.: US 2010/0109311 A1
(43) Pub. Date: May 6, 2010

(54) FUEL TANK SUPPORTING STRUCTURE

(75) Inventors: Kurumi Yoshida, Shizuoka-ken (JP); Takayuki Ota, Shizuoka-ken (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Suzuki Motor Corporation, Shizuoka-ken (JP)

(21) Appl. No.: 12/603,799

(22) Filed: Oct. 22, 2009

(30) Foreign Application Priority Data
Oct. 31, 2008 (JP) 2008-281094

(51) Int. Cl. B60P 3/22

(52) U.S. Cl. 280/834

(57) ABSTRACT

A fuel tank supporting structure for supporting a fuel tank (7) under the floor of a vehicle (1) is comprises a pair of right and left tank belts (8) each stretched in the vehicle longitudinal direction at two sites separated from each other in the vehicle width direction to support the fuel tank. Right and left fixing points (81) on the vehicle front side of the tank belts are each disposed aside in the vehicle width direction with respect to right and left fixing points (82) on the vehicle rear side so that each of the tank belts extends slantwise with respect to the vehicle longitudinal direction in plan view. In the bottom surface portion of the fuel tank supported by the tank belts, right and left engagement grooves (71, 72) engaging with the tank belts are provided.

### CROSS-REFERENCE TO RELATED APPLICATIONS

The present application claims priority from Japanese Patent Application No. 2008-281094, filed in the Japanese Patent Office on Oct. 31, 2008, the disclosure of which is hereby incorporated herein by reference.

### FIELD OF THE INVENTION

The present invention relates to a fuel tank supporting structure for a motor vehicle.

### BACKGROUND OF THE INVENTION

Generally, a fuel tank for a front engine vehicle is installed on the floor bottom surface side by a pair of right and left tank belts set in the longitudinal direction to prevent an influence exerted by torsion or the like of a vehicle body during running (refer to JP2007-118635A). Also, considering safety at the time of collision, the fuel tank is arranged under a rear seat so as to be less liable to be affected by rear end collision.

If a load is applied to the above-described vehicle from the rear direction, a force in the direction opposite to the load is exerted on the tank belts by the inertia of the fuel tank, even if the load is a low one that does not cause significant deformation of the vehicle body. In particular, for a fuel tank fully loaded with a fuel, a high inertial force acts, and the slippage and elongation of tank belts and the displacement of fuel tank resulting therefrom increase non-negligibly. Therefore, the fuel tank and peripheral parts thereof may be damaged by the interference with the peripheral part. By the relative shift between the tank belts and the fuel tank, the force vector of the tank belts to the vehicle body fixing points is changed, and therefore, an excessive load may be applied to either of the front and rear fixing points of the tank belts.

### BRIEF SUMMARY OF THE INVENTION

The present invention has been made in view of the above circumstances, and accordingly, an object thereof is to provide a fuel tank supporting structure capable of improving the support stability against a load applied from the vehicle rear direction.

To solve the problem with the conventional art, the present invention provides a fuel tank supporting structure for supporting a fuel tank under the floor of a vehicle, the structure comprising a pair of right and left tank belts each stretched in the vehicle longitudinal direction at two sites separated from each other in the vehicle width direction to support the fuel tank, wherein right and left fixing points on the vehicle front side of the pair of right and left tank belts are each disposed aside (close to the right and left sides) in the vehicle width direction with respect to right and left fixing points on the vehicle rear side so that each of the tank belts extends slantwise with respect to the vehicle longitudinal direction in plan view; and a pair of right and left engagement grooves engaging with the tank belts are provided in the bottom surface portion of the fuel tank supported by the tank belts.

By the above-described configuration, in the case in which a light load that does not cause significant deformation is applied from the vehicle rear to a structural element around the fuel tank, and a force in the direction opposite to the load is applied to the tank belts by the inertia of the fuel tank, the edge portions on the inside in the vehicle width direction of the tank belts are pressed against the inside parts of the right and left engagement grooves (concave beads) by the wedge action due to the tilting arrangement of the right and left engagement grooves and the tank belts, so that the movement in the vehicle longitudinal direction of the fuel tank is restrained by a frictional force acting therebetween. Thereby, a relative positional shift between the fuel tank and the tank belts, abrasion of the tank belts caused by the positional shift, and interference of the fuel tank with the peripheral parts can be suppressed.

Also, the load direction in which the edge portions on the inside in the vehicle width direction of the belts are pressed against the inside parts of the right and left engagement grooves (concave beads) is a direction in which the bottom surface member of the fuel tank is compressedly deformed, so that improvement in durability can be anticipated as compared with the case of tensile deformation. Furthermore, since the shift of the fuel tank is suppressed, variations in the force vector of the tank belts to the vehicle body fixing points are suppressed. Therefore, the stress change and stress concentration due to the change in load to the fixing points can be reduced.

In the present invention, it is preferable that a concave or convex bead extending in the vehicle longitudinal direction be formed in the vicinity of the engagement grooves in the bottom surface portion of the fuel tank. In this configuration, by the improvement in the rigidity in the vehicle longitudinal direction in the bottom surface portion of the fuel tank and the surface rigidity, the aforementioned wedge action can be obtained evenly throughout the entire section of engagement of the tank belts with the engagement grooves, so that the movement in the vehicle longitudinal direction of the fuel tank can be restrained more surely.

In the present invention, it is preferable that the vehicle include right and left rear floor side members extending in the vehicle longitudinal direction on both sides of a vehicle body rear part; a first cross member provided between the right and left rear floor side members; a second cross member provided between the right and left rear floor side members at the rear of the first cross member; a pair of right and left sub members extending in the vehicle longitudinal direction, which are provided between the first and second cross members, and right and left fixing points on the vehicle rear side of the pair of right and left tank belts be disposed in the vicinity of joint parts of the first cross member to the sub members. In this configuration, the fixing points on the vehicle rear side of the right and left tank belts are set in highly rigid portions of the rear floor. Therefore, this configuration is advantageous in that the installation rigidity of the tank belts can be secured easily, and a change in stress to the fuel tank due to relative displacement of the fixing points is reduced.

In the present invention, it is preferable that the rigidity of a region surrounded by the first cross member, the second cross member, and the pair of right and left sub members be set so as to be higher than the rigidity of peripheral members. In this configuration, local deformation to the outside in the width direction of the fixing points on the vehicle rear side of the right and left tank belts is reduced, and also a portion for absorbing a load by the deformation of the peripheral members having a relatively low rigidity can be secured.

### BRIEF DESCRIPTION OF THE DRAWINGS

FIG. 1 is a perspective view of a vehicle rear part to which a fuel tank supporting structure in accordance with the present invention is applied, being viewed from the side and above in a state in which a rear door and a quarter panel are removed;

FIG. 2 is a bottom plan view of a vehicle rear part provided with a fuel tank supporting structure in accordance with an embodiment of the present invention;

FIG. 3 is a perspective view of a vehicle rear part to which a fuel tank supporting structure in accordance with the present invention is applied, being viewed from the rear bottom side;

FIG. 4 is a bottom plan view of a fuel tank in accordance with an embodiment of the present invention; and

FIG. 5 is a bottom plan view of a vehicle rear part provided with a fuel tank supporting structure in accordance with an embodiment of the present invention.

### DETAILED DESCRIPTION OF THE INVENTION

An embodiment of the present invention will now be described in detail with reference to the accompanying drawings.

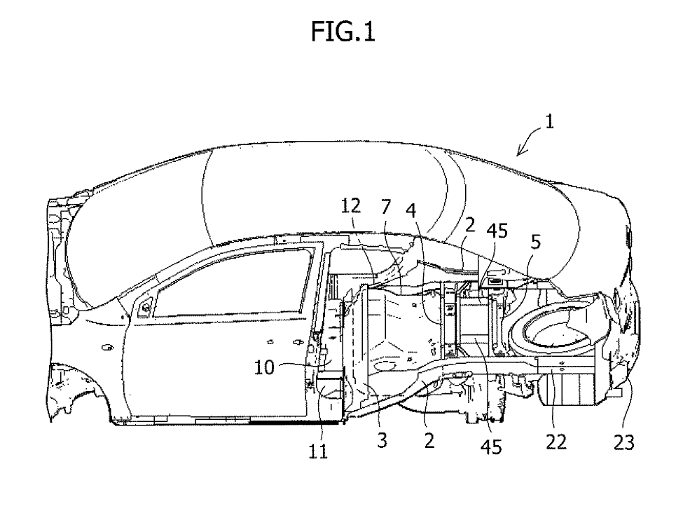

FIG. 1 is a perspective view of a vehicle 1 to which a fuel tank supporting structure in accordance with the present invention is applied, being viewed from the side and above in a state in which a rear door, a quarter panel, and a rear floor panel are removed. In FIG. 1, on the vehicle 1, a rear floor 12 at the rear of a rear seat position is set at a position higher than a front floor 11, and rear floor side members 2 are disposed along both the side portions thereof.

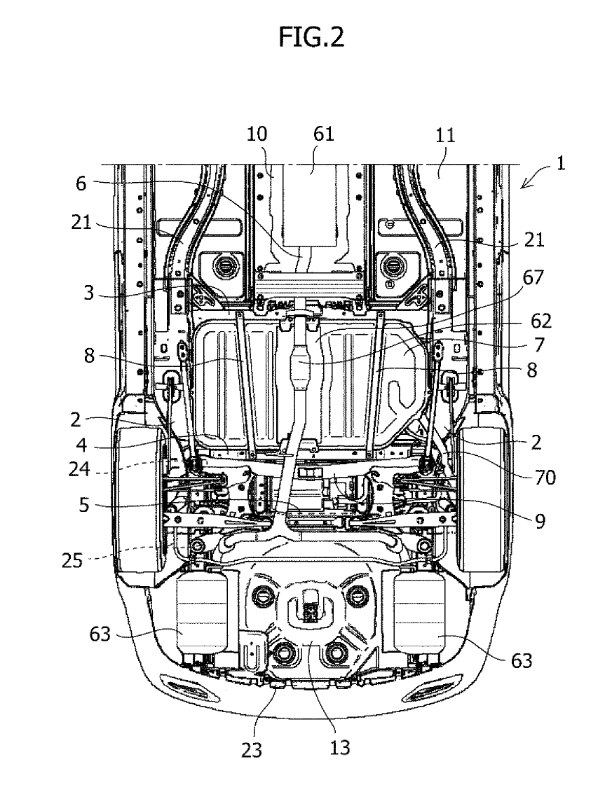

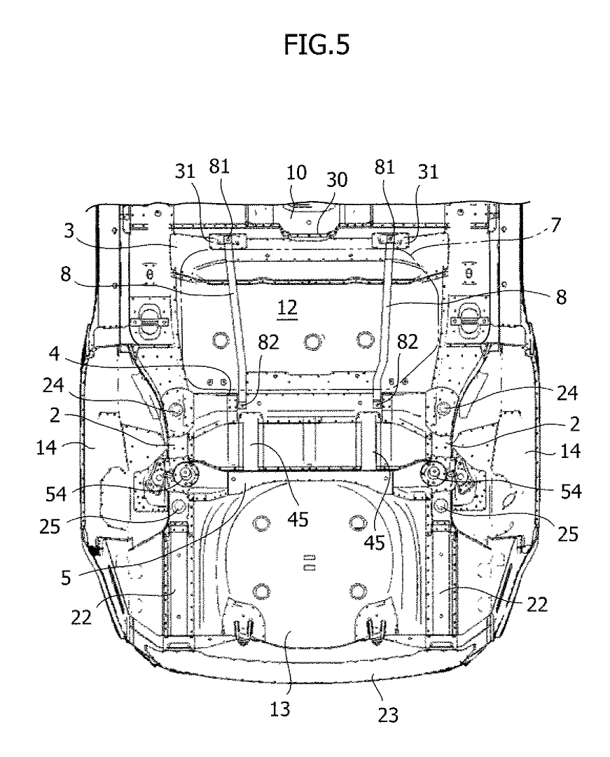

The rear floor side members 2 rise slantwise toward the rear from the front floor 11, reaching the height of the rear floor 12 in the rear portion of a vehicle compartment while curving so as to keep away from right and left rear wheel houses 14 (FIG. 5), and extend linearly toward the vehicle rear end. At the rear ends of the rear floor side members 2, crush boxes 22 are extendingly provided respectively, and to the rear ends of the crush boxes 22, a rear bumper member 23 (rear bumper) is joined. Also, to the front end portions of the rear floor side members 2, front floor side members 21 (FIG. 2) are connected respectively.

Between the right and left rear floor side members 2, three rear floor cross members 3, 4 and 5 are provided so as to be separated from each other in the vehicle longitudinal direction, and a fuel tank 7 is arranged in a space in the bottom portion of the rear floor 12 under the rear seat, which space is defined between the rear floor front cross member 3 located at the very front position and the rear floor center cross member 4 located at the rear thereof. A supporting structure for the fuel tank 7 is described later.

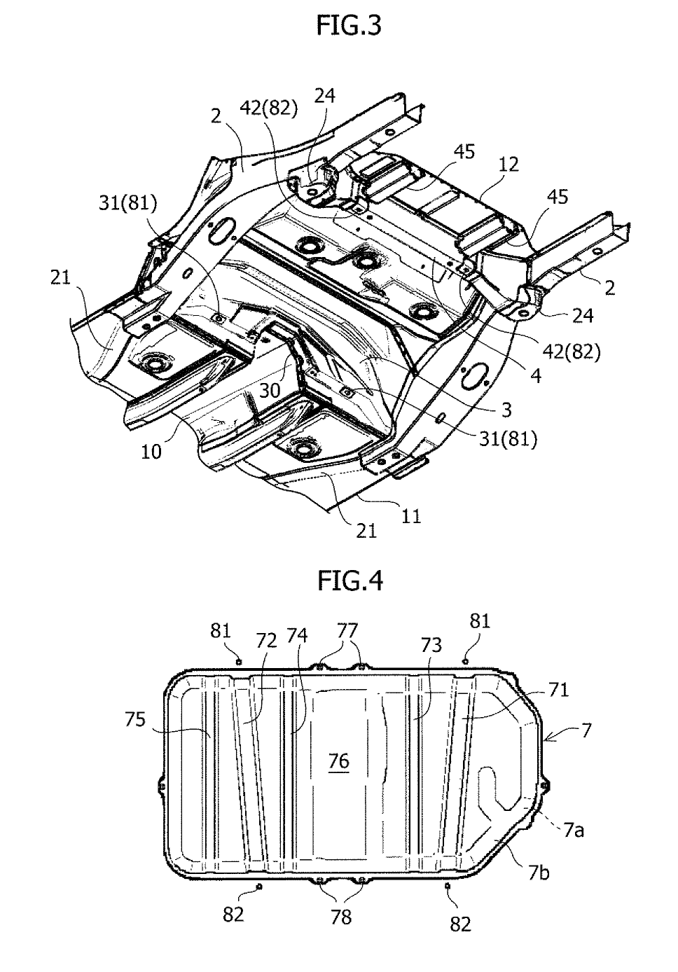

The rear floor front cross member 3 (third cross member) extends in the vehicle width direction in a step portion between the front floor 11 and the rear floor 12, sloping upward from the rear end of the front floor 11, and is joined to the front end portion of the rear floor 12 in an upper rear end portion thereof. In the central bottom portion of the rear floor front cross member 3, an arch-shaped part 30 (FIG. 3, FIG. 5) corresponding to a floor tunnel 10 is provided.

The rear floor center cross member 4 (first cross member) extends in the vehicle width direction on a high surface of the rear floor 12 at the rear of the rear floor front cross member 3, and rigidly joined to the rear floor side members 2 in the right and left end portions. To the bottom surfaces of the rear floor side members 2 adjacent to the joint parts, mounting seats 24 (FIG. 5) for a subframe 9 (FIG. 2) pivotally supporting a suspension arm for rear wheels are joined respectively. As shown in FIG. 2, the subframe 9 is formed into a pound sign shape by channel materials or pipe materials, and is attached at four locations of the mounting seats 24 and mounting seats 25 provided on the bottom surface close to the rear ends of rear floor side members 2 via a rubber bush or the like.

The rear floor rear cross member 5 (second cross member) extends in the vehicle width direction on a high surface of the rear floor 12 at the rear of the rear floor center cross member 4, and rigidly joined to the rear floor side members 2 in the right and left end portions. On the bottom surfaces of the connecting portions, mounting seats 54 (FIG. 5) for suspension springs (not shown) are arranged. The edge portion on the vehicle rear side of the rear floor rear cross member 5 is joined to a floor panel defining a spare tire housing 13 under a cargo compartment floor.

The rear floor center cross member 4 and the rear floor rear cross member 5 located at the rear thereof are connected to each other by a pair of rear floor cross member braces 45 (sub members) provided at two right and left locations, so that a rectangular frame part is formed by the front and rear cross members 4 and 5 and the right and left rear floor cross member braces 45. In the case in which the rigidity of this rectangular frame part is set so as to be higher than the rigidity of the peripheral members, the rigidity between right and left fixing points 82 on the vehicle rear side of tank belts 8 is secured, so that the displacement can be reduced, and on the other hand, a portion for absorbing a load from the rear by the deformation of the peripheral members that are easily deformed relatively can be secured.

Next, the fuel tank 7 and the supporting structure therefor are explained with reference to FIGS. 2 to 5. FIG. 2 is a rear bottom plan view of the vehicle 1, and FIGS. 3 and 5 are a perspective view and a bottom plan view, respectively, showing only the vehicle body structure. In these figures, the fuel tank 7 is accommodated from the lower side in a space in the bottom portion of the rear floor 12 under the rear seat, the space being surrounded by the right and left rear floor side members 2, and the rear floor front cross member 3 and the rear floor center cross member 4 that are provided therebetween so as to be separated from each other in the front and rear direction. Also, the fuel tank 7 is supported from the bottom side by the pair of right and left tank belts 8 provided between the rear floor front cross member 3 and the rear floor center cross member 4 in a state in which the top portion thereof is in contact with the bottom surface of the rear floor 12 via cushioning materials (sealers, not shown) arranged at several spots.

As shown in FIG. 5, right and left fixing points 81 on the vehicle front side of the tank belts 8, which are disposed on the rear floor front cross member 3, are provided close to the side in the vehicle width direction with respect to the right and left fixing points 82 on the vehicle rear side, which are disposed on the rear floor center cross member 4, thereby each of the tank belts 8 extends slantwise with respect to the vehicle longitudinal direction in plan view. At the fixing points 81 and 82 of the tank belts 8, reinforcing brackets 31 and 42 are provided, respectively.

The fuel tank 7 consists of a resin-made tank of a blow molded product or an injection molded product that is formed by joining the peripheral edge portions of the injection molded top and bottom tank shells to each other, or a metallic tank formed by joining the peripheral edge portions of the press molded top and bottom tank shells to each other. As shown in FIG. 4, the bottom surface side (a bottom shell 7b) of the fuel tank 7 is provided with a plurality of (five in the example shown in FIG. 4) concave beads 71 to 75 extending in the vehicle longitudinal direction.

Among these concave beads 71 to 75, the paired concave beads 71 and 72 arranged at the right and left of the fuel tank 7, which are engagement grooves (support surfaces) engaging with the tank belts 8, are disposed linearly so as to be slantwise with respect to the vehicle longitudinal direction like the tank belts 8. Three other concave beads 73 to 75, which are reinforcing beads for reinforcing the tank shell, are disposed in parallel with the vehicle longitudinal direction in this example. However, these concave beads 73 to 75 may be disposed slantwise. The top surface side (a top shell 7a) is also provided with the similar reinforcing beads. The reinforcing beads may be convex beads. Also, the concave beads 71 and 72 each may be defined by two parallel convex beads.

The central portion on the bottom surface of the fuel tank 7 is slightly depressed with respect to the right and left sides thereof to form a relief 76 from an exhaust pipe 6, and as shown in FIG. 2, the relief 76 is provided with a heat insulating board 67 for protecting the bottom surface of the fuel tank 7 from heat generated from the exhaust pipe 6 (a sub muffler 62). The heat insulating board 67 is fixed to fixing parts 77 and 78 (FIG. 4) provided in the flange portions at the central front end and the central rear end of the fuel tank 7. The exhaust pipe 6 extends from a primary catalyst 61 in the floor tunnel 10 to the rear passing through the bottom side of the fuel tank 7, and is connected to mufflers 63 after being divided into the right and left along the front edge of the spare tire housing 13.

If a light load is applied from the rear to the vehicle 1 equipped with the above-described supporting structure for the fuel tank 7, due to the inertia of the fuel tank 7, an inertial force in the direction opposite to the load acts on the right and left tank belts 8. As a result, by the wedge action due to the tilting arrangement of the right and left concave beads 71 and 72 and the tank belts 8, the edge portions on the inside in the vehicle width direction of the tank belts 8 are pressed against the inside walls of the right and left concave beads 71 and 72, so that the movement toward the vehicle longitudinal direction of the fuel tank 7 is restrained by a frictional force acting therebetween. Thereby, a relative positional shift between the fuel tank 7 and the tank belts 8, abrasion of the tank belts 8 caused by the positional shift, and interference of the fuel tank 7 with the peripheral parts can be suppressed.

Also, the load direction in which the edge portions on the inside in the vehicle width direction of the tank belts 8 are pressed against the inside parts of the right and left concave beads 71 and 72 is a direction in which the bottom surface member of the fuel tank 7 is compressedly deformed, so that the improvement in durability can be anticipated as compared with the case of tensile deformation. Also, since the shift of the fuel tank 7 is suppressed, variations in the force vector of the tank belts 8 to the vehicle body fixing points 81 and 82 are suppressed. Therefore, the stress change and stress concentration due to the change in load to the fixing points 81 and 82 can be reduced, and the decrease in strength due to fatigue in both end portions of the tank belts can be suppressed.

Furthermore, the concave beads 73 to 75 extending in the vehicle longitudinal direction are formed in the vicinity of the concave beads 71 and 72 in the bottom surface portion of the fuel tank 7, and therefore the rigidity in the vehicle longitudinal direction and the surface rigidity of the bottom surface portion of the fuel tank 7 are improved. Thereby, the tank belts 8 are pressed evenly against the inside walls of the right and left concave beads 71 and 72 throughout the entire length in the lengthwise direction, so that a steady locking force is obtained, and therefore the movement in the vehicle longitudinal direction of the fuel tank 7 can be restrained more surely.

Also, in the case in which a transverse load is applied to the fuel tank 7, for example, at the time of vehicle turning, by the tilting arrangement of the right and left concave beads 71 and 72 and the tank belts 8, a component of force directed toward the vehicle longitudinal reverse direction is generated on the right and left sides. Therefore, the tightening force of the tank belts 8 increases, so that the transverse movement of the fuel tank 7 is restrained.

Also, since the fixing points 82 on the vehicle rear side of the right and left tank belts 8 are arranged at positions at which the rigidity is high in the vicinity of the joint parts of the rear floor rear cross member 5 to the rear floor cross member braces 45 (sub member), the installation rigidity of the tank belts 8 can be secured easily.

The above is a description of the embodiment of the present invention. The present invention is not limited to the above-described embodiment, and various modifications and changes can further be made based on the technical concept of the present invention.

1. A fuel tank supporting structure for supporting a fuel tank under the floor of a vehicle, the structure comprising a pair of right and left tank belts each stretched in the vehicle longitudinal direction at two sites separated from each other in the vehicle width direction to support the fuel tank,
wherein right and left fixing points on the vehicle front side of the pair of right and left tank belts are each disposed aside in the vehicle width direction with respect to right and left fixing points on the vehicle rear side so that each of the tank belts extends slantwise with respect to the vehicle longitudinal direction in plan view; and a pair of right and left engagement grooves engaging with the tank belts are provided in the bottom surface portion of the fuel tank supported by the tank belts.

2. The fuel tank supporting structure according to claim 1, wherein a concave or convex bead extending in the vehicle longitudinal direction is formed in the vicinity of the engagement grooves in the bottom surface portion of the fuel tank.

3. The fuel tank supporting structure according to claim 1, wherein the vehicle includes right and left rear floor side members extending in the vehicle longitudinal direction on both sides of a vehicle body rear part; a first cross member provided between the right and left rear floor side members; a second cross member provided between the right and left rear floor side members at the rear of the first cross member; a pair of right and left sub members extending in the vehicle longitudinal direction, which are provided between the first and second cross members, and right and left fixing points on the vehicle rear side of the pair of right and left tank belts are disposed in the vicinity of joint parts of the first cross member to the sub members.

4. The fuel tank supporting structure according to claim 3, wherein the rigidity of a region surrounded by the first cross member, the second cross member, and the pair of right and left sub members is set so as to be higher than the rigidity of peripheral members.
